(19) United States
(12) Patent Application Publication
(10) Pub. No.: US 2008/0222254 A1
(43) Pub. Date: Sep. 11, 2008

(54) Systems and methods for sending customized emails to recipient groups

(76) Inventor: Shubham Mukherjee, Cambridge, MA (US)

Correspondence Address: SHUBHAM MUKHERJEE, 18 CHAUNCY ST, #15, CAMBRIDGE, MA, 02138, US

(21) Appl. No.: 11/684,606

(22) Filed: Mar. 10, 2007

(51) Int. Cl. G06F 15/16

(52) U.S. Cl. 709/206

(57) ABSTRACT

Systems and methods for allowing a user to send customized electronic mails to recipients, comprising providing a graphical window on a display screen of an electronic device, allowing the user to input a message which is displayed within the graphical window, allowing the user to identify portions of the message as being intended for certain recipient groups, creating an electronic mail for each recipient group based on the portions of the message identified as being intended for that recipient group, and sending the electronic mails.

### BACKGROUND

Electronic mail, or “email,” is one of the most important ways that people communicate with each other. An email generally refers to a communication that is transmitted electronically and includes a message from one or more senders to one or more recipients.

A sender typically uses an electronic device to compose and transmit an email. Similarly, a recipient typically uses an electronic device to receive and read an email. Examples of electronic devices that can be used by a sender or a recipient include personal computers, personal digital assistants, or cell phones.

The sender's electronic device typically transmits the email to the recipient's electronic device over a network. For example, email can be transmitted from a sender's computer to a recipient's computer over the Internet or any other computer network. Alternatively, email can be transmitted electronically from a sender's cellular telephone to a recipient's cellular telephone over a cellular network. When the emails include only text, as is often the case when the sender's electronic device is a cell phone, the emails are sometimes referred to as text messages.

Senders and recipients typically compose, send, receive, and read emails on their electronic devices using software called an email client. An email client provides the user interface and other software-level implementations for composing, sending, receiving, and reading email.

While the hardware and software systems that deliver and process email have become faster, more efficient, and more user-friendly, there is still much room for improvement. In particular, existing email clients do not allow a sender to send quickly and efficiently separate emails with respective separate messages to respective groups of recipients without having to manually compose and send each of the emails from scratch. There exists a need to address this deficiency.

### SUMMARY OF THE INVENTION

As mentioned above, existing email clients do not allow a sender to quickly and efficiently send separate electronic mails with respective separate messages to multiple recipients without having to manually compose and send each of the electronic mails from scratch. This can be highly inefficient, especially when the separate electronic mails have large portions of text that are in common.

For example, if the sender would like to use email to send personalized dinner invitations to two colleagues, one of whom (Colleague A) lives in Harvard Square while the other (Colleague B) lives in Back Bay, he would have to do the following:
Open a new email window (also referred to herein as a “graphical window”)
Identify Colleague A as the recipient (by, for example, typing Colleague A's email address into a “To:” field in the email client).
Type in the following message to Colleague A in the email client:
   “Hi. I am delighted that you will be coming over for dinner.
   To get to my house from your house in Harvard Square, you should <<directions from the Harvard Square would go here>>.
   Again, I am excited to see you. Sincerely, Sender.”
Send the message.
Open a second new email window.
This time, identify Colleague B as the recipient
Type in the following message to Colleague B in the email client:
   “Hi. I am delighted that you will be coming over for dinner.
   To get to my house from your house in Back Bay, you should <<directions from the Back Bay would go here>>.
   Again, I am excited to see you. Sincerely, Sender.”
Send the message.
   This process requires the sender to manually compose two emails from scratch, which takes time and is a hassle for the sender. Moreover, since both of the emails have large portions of their messages in common, the sender has to enter certain pieces of text twice. This is inefficient. Instead, if the sender were able to send both of these personalized emails by only having to compose a single message, the process would become much more efficient.

In one aspect, this invention can allow the user to send both of these personalized emails by only having to compose a single message, but identifying portions of it as being intended for particular recipient groups. In particular, in one an exemplary method consistent with the invention, the sender would proceed as follows:
Open a new email window
Identify Colleague A as being in the first recipient group.
Identify Colleague B as being in the second recipient group.
Type the following message into the window:
   “Hi. I am delighted that you will be coming over for dinner.
   To get to my house from your house in Harvard Square, you should <<directions from Harvard Square would go here.>> Back Bay, you should <<directions from Back Bay would go here.>>
   Again, I am excited to see you. Sincerely, Sender.”
Select the portion of the message “Harvard Square, you should <<directions from the Harvard Square would go here.>>” and identify it as being intended for the first recipient group.
Select the portion of the message “Back Bay, you should <<directions from Back Bay would go here.>>” and identify it as being intended for the second recipient group.
Instruct the email client to send the message (by, e.g., clicking on a “Send” button).
Then, the email client will then generate two emails, one intended for the first recipient group and one intended for the second recipient group. In the first recipient group's email, the email client will include the portion that the sender identified as being intended for the first recipient group. However, the email client will suppress this portion from the second recipient group's email. Similarly, in the second recipient group's email, the email client will include the portion that the sender identified as being intended for the second recipient group, while suppressing this portion from the first recipient group's email. Finally, For portions of the text that were not specifically identified as being for either the first or the second recipient group will be included in both emails The email client sends these two emails.
   Thus, the above-described process saves the sender from having to manually compose two emails from scratch. In part, the systems and methods described herein are for allowing a user to identify different portions of a message as being identified for different recipient groups, and for allowing an email client to parse the message and generate the appropriate emails based on the identified portions and the identified recipient groups. As shown in the illustrative example above, this will save time and hassle for a sender.

In one aspect, this invention provides a method for allowing a user to send customized electronic mails to a plurality of recipients, comprising providing a graphical window on an electronic display of an electronic device for inputting a message, allowing the user to input a message, allowing the user to identify a first portion of the message as intended for a first recipient group, allowing the user to identify a second portion of the message as intended for a second recipient group, creating, based at least in part on the identified first portion of the message, a first electronic mail for delivery to the first recipient group, creating, based at least in part on the identified second portion of the message, a second electronic mail for delivery to the second recipient group; and sending the first and second electronic mails.

At least one of the first recipient group and the second recipient group may consist of a single recipient.

The method may include allowing the user to identify additional portions of the message as intended for respective additional recipient groups, creating, based on the identified additional portions of the message, respective additional electronic mails and sending the additional electronic mails.

The method may include allowing a generic portion of the message to be included in both the first and second electronic mails. The method may include allowing the user to identify multiple parts of the message to be the first portion of the message, or allowing the user to identify multiple parts of the message to be the second portion of the message. The method may include allowing the user to input the message; allowing the user, subsequent to the user inputting the message, to identify the first portion of the message as intended for the first recipient group; and allowing the user, subsequent to the user identifying the first portion of the message, to identify the second portion of the message as intended for the second recipient group.

The method may include allowing the user to identify the first portion of the message comprises allowing the user to click and drag a cursor icon over the first portion of the message.

The method may include creating the first electronic mail comprises including the first portion of the message in the first electronic mail but not including it in the second electronic mail, and creating the second electronic mail comprises including the second portion of the message in the second electronic mail but not including it in the first electronic mail.

Allowing the user to identify the first portion of the message may comprise allowing the user to select a first-recipient-group-mode, and allowing the user to enter the first portion of the message after the user selects the first-recipient-group-mode; wherein the identification of the entered first portion of the message as the first portion is based on the first-recipient-group-mode.

The method may include allowing the user to identify a location in the graphical window; and allowing the user to enter the first portion of the message beginning at about the location.

Allowing the user to identify the second portion of the message may comprise allowing the user to select a second-recipient-group-mode; and allowing the user to enter the second portion of the message after the user selects the second-recipient-group-mode; wherein the identification of the entered second portion of the message as the second portion is based on the second-recipient-group-mode.

The method may include allowing the user to toggle between selections of the first-recipient-group-mode and the second-recipient-group-mode, thereby allowing the user to modify the first and second portions of the message, wherein the portion of the message being modified is based on a current recipient-group-mode selection.

Allowing the user to modify the first and second portions of the message may comprise allowing the user to at least one of add to, delete from, and change the first portion and the second portion.

Sending the first and second electronic mails may comprise sending text messages from a portable handheld wireless communication device. Providing a graphical window for inputting a message may comprise providing a graphical window on a screen of a portable handheld wireless communication device.

The method may include allowing the user to identify the first portion of the message by dragging at least one of a finger and a stylus over a portion of the screen, the portion of the screen being representative of the first portion of the message.

In another aspect, this invention provides a system for allowing a user to send customized electronic mails to a plurality of recipients, comprising an electronic device for communicating with other electronic devices; a display operably coupled to the electronic device for displaying a graphical window; an interface for allowing the user to input a message to be displayed within the graphical window; programmable memory for maintaining respective first and second membership lists of first and second recipient groups; additional programmable memory for storing indicators identifying first and second portions of the message; a parser for creating respective first and second electronic mails based on the first and second portions of the message and the first and second recipient groups; and a transmitter for transmitting the electronic mails.

The electronic device may comprise at least one of a personal digital assistant and a cellular telephone. The display may be a touch-sensitive display for allowing the user to identify the first and second portions of the message by using a finger to select the first and second portions of the message.

In another aspect, the invention provides a system for allowing a user to organize portions of an electronic mail message based on intended recipients of the portions of the electronic mail message, comprising: an electronic device for communicating with other electronic devices; an electronic touch-sensitive display operably coupled to the electronic device for displaying a graphical window; an interface for allowing the user to input a message to be displayed within the graphical window; programmable memory for maintaining respective membership lists for recipient groups; programmable memory for storing respective indicators identifying portions of the message; and programmable memory for storing indicators associating ones of the recipient groups with ones of the portions of the message.

### BRIEF DESCRIPTION OF THE DRAWINGS

FIG. 1A shows a flow diagram illustrating an exemplary method for allowing a user to send customized electronic mails to a plurality of recipients.

FIG. 1B shows a screen shot of an electronic mail client that is used to send customized electronic mails to a plurality of recipients, according to one illustrative embodiment of the invention.

FIG. 1C shows how the email client generates three customized electronic mails, all generated in a single message-input session, that will be sent to three respective recipient groups.

FIG. 2 shows a screen shot of an electronic mail client that is used to send customized electronic mails to two groups of recipients according to one illustrative embodiment of the invention, and illustrates an exemplary method for identifying the which portions of the message should be included in the electronic mails for which of the two recipient groups.

FIG. 3 shows a screen shot of an electronic mail client that is used to send customized electronic mails to two groups of recipients according to one illustrative embodiment of the invention, and illustrates another exemplary method for identifying which portions of the message should be included in the electronic mails for which of the two recipient groups.

FIG. 4 shows a computer system that runs the email client depicted in FIGS. 1-3, according to an illustrative embodiment of the invention.

### DESCRIPTION

These and other features and advantages will be more fully understood by the following illustrative description with reference to the appended drawings, in which like elements are labeled with like reference designations, and in which screen shots of graphical displays are not actual screen shots but instead are illustrative representations of screen shots. The drawings may not be drawn to scale.

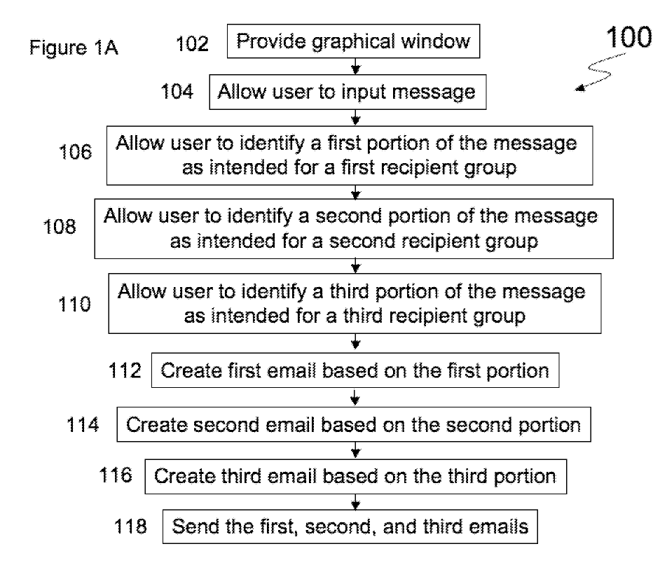

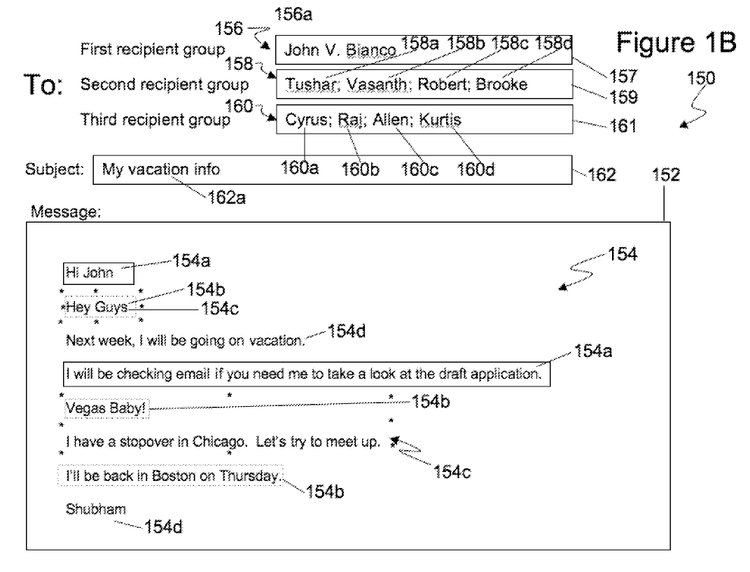

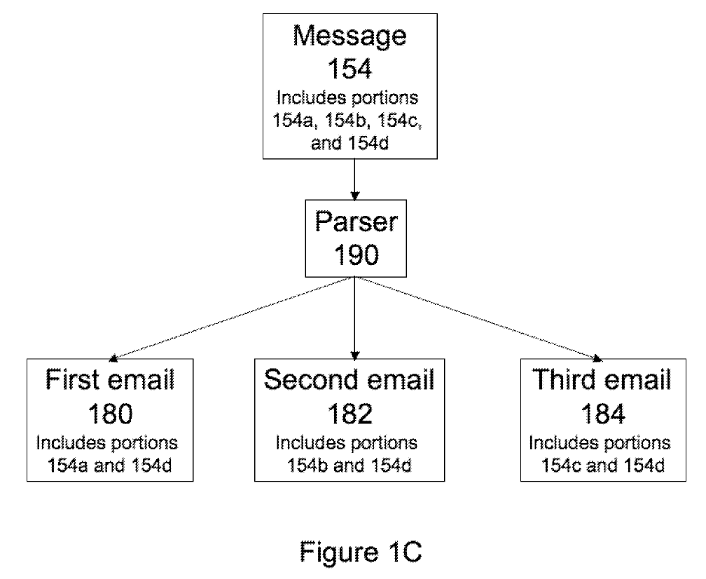

FIG. 1A shows a flow diagram illustrating an exemplary method 100 for allowing a user to send customized electronic mails to a plurality of recipients. FIG. 1B shows a screen shot 150 of an electronic mail client that is used to send customized electronic mails to a plurality of recipients, according to one illustrative embodiment of the invention.

Other than the systems and methods described herein, the email client is similar in form and function to email clients known in the art. For example, the email client may be similar to Microsoft Outlook, Google's Gmail, or other email clients. Alternatively, the email client may in fact be one of these email clients, and the systems and methods of this invention are implemented as a modification or plug-in to these email clients.

The screen shot 150 can be from any electronic display of any electronic device, as will be described in more detail below. In this example, the screen shot 150 is from a monitor of a personal computer. The exemplary method 100 of FIG. 1A will now be described with respect to the screen shot 150 of FIG. 1B.

The screen shot 150 shows several fields that the sender fill in. In particular, the screen shot 150 shows a graphical window 152, provided by the email client (step 102), in which the sender inputs a message 154. The screen shot 150 also shows the recipient group fields 157, 159, and 161 for identifying recipients, and the subject field 162 for identifying a subject of the message 154.

Various portions of the message 154 will be sent to various recipient groups. In this example, there are three recipient groups: a first recipient group 156, a second recipient group 158, and a third recipient group 160. The first recipient group is the sender's boss, the second recipient group is a group of the sender's close friends who live in Boston, and the third recipient group is a group of the sender's close friends who live in Chicago. The first recipient group 156 includes the single recipient 156a whose name is “John Bianco.” The second recipient group 158 includes 4 recipients 158a-d, named Tushar, Vasanth, Robert, and Brooke. The third recipient group includes 4 recipients 160a-160a, named Cyrus, Raj, Allen, and Kurtis.

In this example, these recipients are identified by their names, which are entered by the sender in the recipient fields 157, 159, and 161. The email client accesses a software-based address book that maps these names into email addresses when it is ready to send the emails. Alternatively, the sender may directly enter email addresses into the fields 157, 159, and 161.

As mentioned, the screen shot 150 includes a subject field 162. The sender enters a subject into this subject field 162, which in this example is the subject 162a “Vacation info.”

The method 100 includes the steps of allowing the user to identify a first portion 154a of the message 154 as intended for a first recipient group 156 (step 106), allowing the user to identify a second portion 154b of the message 154 as intended for a second recipient group 158 (step 108), and allowing the user to identify a third portion 154c of the message 154 as intended for a third recipient group 160 (step 110). The text in the first portion 154a of the message 154 is boxed with a solid line, the text in the second portion 154b of the message 154 is boxed with a dotted line, and the text in the third portion 154c of the message 154 is boxed with *'s. As shown, each portion need not be contiguous, and certain parts of text can belong to more than one of these portions.

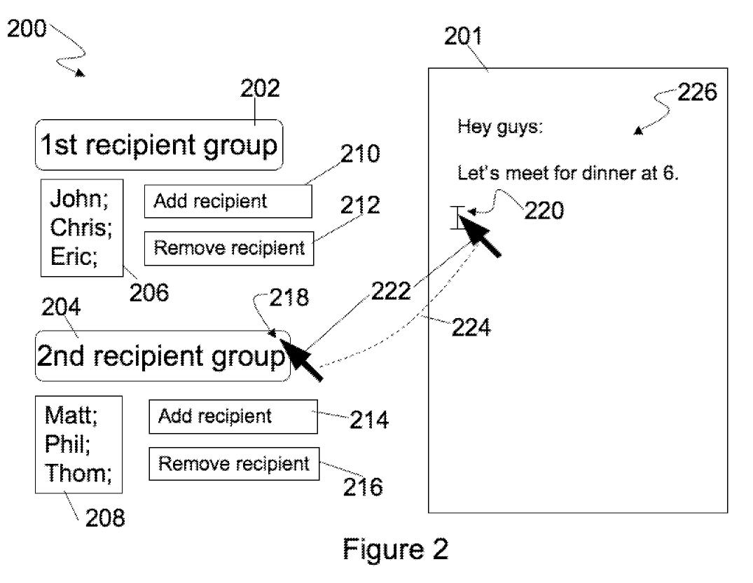

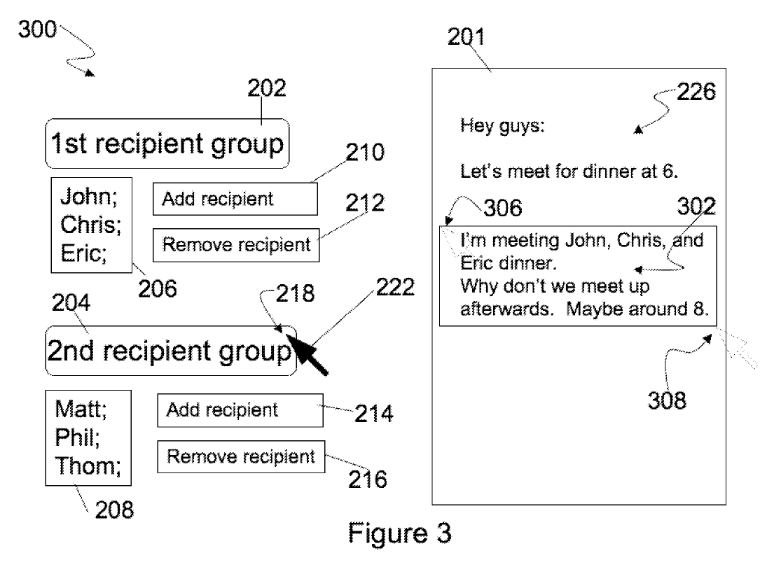

In addition, the message 154 includes a generic portion 154d that is intended for all three of the recipient groups 156, 158, and 160. In this example, the generic portion 154d includes any part of the message 154 that the sender did not identify as being intended for particular recipient groups. In other implementations, the sender proactively identifies a portion as being generic (i.e., intended for all recipient groups). Various exemplary methods that allow the user to apportion the message 154 in this manner will be described with respect to FIGS. 2-3 below.

This method is efficient for several reasons. In one aspect, by apportioning the message such that certain portions are only sent to certain recipient groups, the sender can efficiently send customized emails. For example, the greeting portion “Hi John” of the first portion 154a helps to customize the email that will ultimately be sent to the first recipient group 156 by addressing its member by name. Similarly, the greeting portion “Hey guys” of the second portion 154b and third portion 154c helps to customize the email that will ultimately be sent to the second and third recipient groups 158 and 160. This kind of informal greeting may be appropriate for close friends such as the members of the second and third recipient groups 158 and 160, but inappropriate for the sender's boss 156a. In another aspect, the sender only has to input a single message 154 (i.e., he sends all of his emails in a single message-input session). He does not have to open three separate graphical windows to send the three emails. In yet another aspect, he only needs to enter the common portion of the three emails 154d a single time.

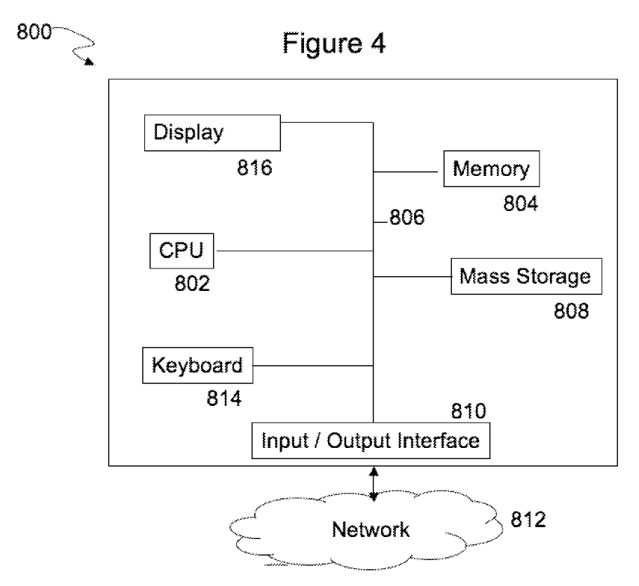

Once the user has inputted the message 154 and apportioned the message into portions 154a-d (methods for apportioning will be described below), the email client creates three emails based on these portions. In particular, as shown in FIG. 1C, the email client creates a first email 180 based on the first portion 154a and the generic portion 154d of the message 154 for delivery to the first recipient group 156 (step 112 of FIG. 1A). The email client also creates a second email 182 based on the second portion 154b and the generic portion 154d of the message 154 for delivery to the second recipient group 158 (step 114). Similarly, the email client creates a third email 184 based on the third portion 154c and the generic portion 154d of the message 154 for delivery to the third recipient group 160 (step 116). Finally, the email client sends the three emails 180, 182, and 184 (step 118) over a network, as will be described in more detail with respect to FIG. 4. The email client sends the first email 180 to members of the first recipient group 156, sends the second email 182 to members of the second recipient group 158, and sends the third email 184 to members of the third recipient group 160.

FIG. 1C shows how the email client generates the three customized electronic mails 180, 182, and 184 that will be sent to three respective recipient groups. In particular, FIG. 1C shows the message 154. After the user identifies the various portions of the message, the sender will indicate that the email client should send the emails (by, e.g., clicking a “Send” button, not shown). The email client includes a parser 190, which then parses the message to create emails based on the identified recipient groups and the identified portions of the message. For example, the parser 190 parses the message 154 to extract portions 154a and 154d, places these portions into a first email 180, and sends the first email 180 to members of the first recipient group 156. Similarly, the parser 190 extracts portions 154b and 154d, places these portions into a second email 182, and sends the second email 182 to members of the second recipient group 158. Finally, the parser 190 extracts portions 154c and 154d, places these portions into a third email 184, and sends the third email 184 to members of the third recipient group 160.

In the example of FIGS. 1A-C, there were three recipient groups. However, this need not be the case. In general, the user can choose how many recipient groups there will be. The number of recipient groups can be 1 or more.

FIG. 2 shows a screen shot 200 of an electronic mail client that is used to send customized electronic mails to groups of recipients according to one illustrative embodiment of the invention, and illustrates an exemplary method for identifying the portions of the message should be included in the electronic mails for each of the recipient groups. In this example, there are two recipient groups, as opposed to the three recipient groups in the example of FIG. 1.

The screen shot 200 shows a graphical window 201 in which a sender inputs a message. The screen shot 200 also shows fields and buttons for managing first and second recipient groups. In particular, it shows a “First Recipient Group” button 202, a first recipient group membership list 206, a first “add recipient” button 210, and a first “remove recipient” button 212. These are used to manage a first recipient group. Similarly, the screen shot 200 shows fields and buttons for managing a second recipient group: a “Second Recipient Group” button 204, a second recipient group membership list 208, a second “add recipient” button 214, and a second “remove recipient” button 216.

A sender manages the membership of the first and second recipient groups by adding or removing members from these recipient groups. In particular, to add members to the first recipient group, the sender clicks on the first “add recipient” button 210. In one implementation, when the sender clicks this button 210, a pop-up window appears on the electronic display with a field in which the sender inputs the name, email address, or other identifying information of one or more additional recipients to be included in the first recipient group. That additional recipient's name(s) (or other identifying information) will then be included in the first recipient group membership list 206, just as “John,” “Chris,” and “Eric” are displayed in the figure.

In order to remove a member from the first recipient group, the sender selects one or more of the names in the first recipient group membership list 206 by clicking on the name(s), and then clicks on the “Remove Recipient” button 212. Members can be similarly added or removed from the second recipient list 208 by using the “add recipient” button 214 and the “remove recipient” button 216.

In one exemplary use, the email client begins in a default generic-mode, wherein text that the sender inputs into the graphical window 201 is classified as a generic portion that is intended to go to the members of both the first and second recipient groups 206 and 208. In this figure, the generic portion 226 is “Hey guys: Let's meet for dinner at 6.” Next, the user will enter a portion of the message which is intended only for members of the second recipient group 208. To do so, the user clicks on the “Second recipient group” button using his mouse and the mouse arrow icon 222. Any mouse and corresponding mouse arrow icon 222 known in the art can be used. When the user does this, the email client enters into a second-recipient-group mode. The user then clicks into the location 220 in the graphical window 201 where he wants a second portion of the message to begin (e.g., by moving the mouse arrow icon along path 224 to location 220 and then clicking). When the sender types, the text that he enters will only be included in a second portion of the message which will only be sent to members of the second recipient group. For example, the text can set forth directions to dinner for Matt, Phil, and Thom, who are members of the second recipient group.

Next, the sender switches the email client into first-recipient-group-mode by clicking on the “First Recipient Group” button 202. When the sender types, the text that he enters will only be included in a first portion of the message which will only be sent to members of the first recipient group. For example, the text can set forth directions to dinner for John, Chris, and Eric, who are members of the first recipient group.

If the sender has entered first-recipient-group-mode by clicking the first recipient group button 202, then the sender can enter generic-mode by again clicking on the first-recipient-group button 202. Similarly, if the sender is in second-recipient-group mode, the sender can enter generic-mode by clicking on the second-recipient-group button 204. In another implementation, there is another button (not shown) that the user can click to enter into generic-mode. The sender can toggle between first-recipient-group-mode, second-recipient-group-mode, and generic-mode as desired and can continue entering text in each of those modes.

Each portion of the message does not need to be a contiguous part of the message. For example, in FIG. 1A, the first portion 154a of the message includes multiple parts, one part saying “Hi John” and another part saying “I will be checking email if you need me to take a look at the draft application.”

To help the user distinguish between the generic portion, the first portion, and the second portion of the entered text, these portions may be color coded. In one example, the following color coding is used. For example: The text in the generic portion appears in black. The text in the first portion is blue, and the “First recipient group button” 202 is also blue to help the user remember that the color blue is associated with the first recipient group. The text in the second portion is green, and the “Second recipient group button” 204 is also green to help the user remember that the color blue is associated with the second recipient group. However, other color schemes can be used.

Similarly, the various portions can be distinguished based on different patterns or designs. Returning briefly to FIG. 1, the text in the first portion 154a of the message 154 is boxed with solid lines, the text in the second portion 154b of the message 154 is boxed with dashed lines, the text in the third portion 154c of the message 154 is boxed with stars, and the text in the generic portion 154d is not boxed at all. In another implementation, the various portions are distinguished based on respective different fonts. More generally, any distinguishing feature can be used.

FIG. 3 shows a screen shot 300 of an electronic mail client that is used to send customized electronic mails to two groups of recipients according to one illustrative embodiment of the invention, and illustrates another exemplary method for identifying which portions of the message should be included in the electronic mails for which of the two recipient groups. The screen shot 300 shows several features similar to features of FIG. 2, including the “First Recipient Group” button 202, the first recipient group membership list 206, the first “add recipient” button 210, the first “remove recipient” button 212, the “Second Recipient Group” button 204, the second recipient group membership list 208, the second “add recipient” button 214, and the second “remove recipient” button 216. The screen shot 300 also shows the graphical window 201, and shows the already-entered generic portion 226 of text within the graphical window 201.

Also in the graphical window 201 is a portion 302 of text that is intended for only the second recipient group consisting of Matt, Phil, and Thom. In this example, the sender identifies this portion 302 of text as a second portion 302 of text. To do this, the sender clicks-and-drags the mouse arrow icon over the portion 302 of the text (e.g., from a first location 306 to a second location 308), and then clicks on the “Second-recipient-group” button 204. In this particular example, there is no first portion of text. Thus, the first recipient group, consisting of John, Chris, and Eric, will only receive the generic portion of text 226. However, if the sender did want to include a portion of text intended for only the first recipient group, he could use a similar method as that described above, except using the “1^{st} recipient group” button 202 instead of the “2^{nd} recipient group” button 204.

In one implementation, the graphical window 201 is on an electronic display that is touch-sensitive. In this case, rather than manipulating a mouse-arrow icon using a mouse, the sender can use his finger. Using the just-described example, the user can identify the portion 302 of text as a second portion 302 of text by dragging his finger over the portion 302 of the text (eg., from a first location 306 to a second location 308), and then touching his finger on the “Second-recipient-group” button 204.

This invention is particularly well-suited for portable devices. As mentioned above, this invention saves the sender from having to retype common portions of text that appear in multiple emails, and also saves the sender from having to open and close a new graphical window for each email. These are tasks which are particularly time consuming and cumbersome on portable devices, which often times do not have convenient input devices (such as full-size keyboards or mouses). Thus, eliminating the need to perform these tasks is particularly beneficial for portable devices.

This invention is, furthermore, particularly well-suited for being implemented on a portable device with a touch-sensitive screen. In the methods described with respect to FIG. 3, the sender performs “click-and-drag” types of maneuvers, which can be difficult to do on portable devices because portable devices typically do not have mouses. But if the portable device has a touch-sensitive screen, the click-and-drag maneuvers are relatively simple. In other implementations, the sender uses a stylus instead of his finger. In some implementations, the sender uses a portable device that does have a mouse.

FIG. 4 shows a computer system that runs the email client depicted in FIGS. 1-3, according to an illustrative embodiment of the invention. A sender uses the computer system 800 to compose and send emails, as described with respect to FIGS. 1-3. The exemplary computer system 800 includes a central processing unit (CPU) 802, a memory 804, and an interconnect bus 806. The CPU 802 may include a single microprocessor or a plurality of microprocessors for configuring computer system 800 as a multi-processor system. The memory 804 illustratively includes a main memory and a read only memory. The computer 800 also includes the mass storage device 808 having, for example, various disk drives, tape drives, etc. The main memory 804 also includes dynamic random access memory (DRAM) and high-speed cache memory. In operation, the main memory 804 stores at least portions of instructions and data for execution by the CPU 802.

The mass storage 808 may include one or more magnetic disk or tape drives or optical disk drives, for storing data and instructions for use by the CPU 802. The mass storage system 808 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 800.

The computer system 800 may also include one or more input/output interfaces for communications, shown by way of example as interface 810 for data communications via the network 812. The emails described above are sent to the network 812 via interface 810. The emails are then transferred to the recipient who may be connected to network 812, or connected to a different network that is somehow, directly or indirectly, linked to network 812.

The data interface 810 may be a modem, an Ethernet card or any other suitable data communications device. The data interface 810 may provide a relatively high-speed link to a network 812, such as an intranet, internet, or the Internet, either directly or through an another external interface (not shown). The communication link to the network 812 may be, for example, optical, wired, or wireless (e.g., via satellite or cellular network). Alternatively, the computer system 800 may include a mainframe or other type of host computer system capable of Web-based communications via the network 812. The data interface 810 allows for delivering content, and accessing/receiving content via network 812.

The computer system 800 also includes suitable input/output ports or use the interconnect bus 806 for interconnection with a local display 816 and keyboard 814 or the like serving as a local user interface for programming and/or data retrieval purposes. Typically, the sender will use the keyboard 814 to enter the text of the messages described above. The user will typically also use a mouse (not shown) as described above.

The components contained in the computer system 800 are those typically found in general purpose computer systems used as servers, workstations, personal computers, network terminals, and the like. In fact, these components are intended to represent a broad category of such computer components that are well known in the art. The system 800, and its various components shown in FIG. 4, may also represent a portable electronic device and its components.

In one embodiment, the email clients of this invention are implemented on computer readable mediums operatively coupled to computer systems, such as system 800. Such a computer readable medium may include the CPU 802, the memory 804, the mass storage 808, and/or other similar mediums external to computer system 800.

In some embodiments, the email client is implemented on a portable device. For example, the email client can be implemented on a personal digital assistant, a cellular telephone, or other portable communications device. One such example is Apple's iPhone.

In one implementation, the email client is implemented on a portable electronic device, such as a cellular phone or an all-purpose portable device, having a touch-sensitive screen. The touch-sensitive screen can be a flexible touch-sensitive screen, such as those described in U.S. Pat. No. 6,490,402, which is incorporated herein by reference in its entirety. Because certain aspects of this invention are particularly beneficial for portable devices, and because flexible screens are particularly well-suited for portable applications (users often have to take the device with the screen on-the-go, and thus store them in cramped storage containers), this invention is particularly well-suited for flexible screens.

Generally, the systems and methods are realized by an email client. The email client may be an application codified in a programming languages based on C, C++, C#, COBOL, BASIC, Java®, assembly language, and/or like computer program languages and may be compatible with platforms such as Windows, Linux, UNIX, Macintosh operating systems, or other operating systems. Certain features may be implemented using scripting languages such as Active Server Pages (ASP), ColdFusion, JavaScript, or .Net.

In one implementation, the computer system 800 is a notebook or subnotebook device and only uses Flash memory, which is beneficial because of faster system start-up times and more reliable memory due to fewer moving parts. In another implementation, the computer system 800 is a portable digital assistant using only Flash memory.

While the example described above related to text-only messages, this need not be the case. Emails can include any one or more of text, images, video files, music files, other multimedia files, html-based media, JAVA-based media, or media based on other programming languages. Any of these can be selected to be included in certain portions of messages to be sent only to particular recipient groups using methods similar to those described above. For example, a user can select an image attachment, and then indicate that the image attachment belongs to a first portion of the message and thus should only be sent to a first recipient group.

While this invention has been particularly shown and described with references to preferred embodiments thereof, it will be understood by those skilled in the art that various changes in form and details may be made therein without departing from the scope of the invention encompassed by the appended claims.

I claim:

1. A method for allowing a user to send customized electronic mails to a plurality of recipients, comprising:
providing a graphical window on an electronic display of an electronic device for inputting a message;
allowing the user to input a message;
allowing the user to identify a first portion of the message as intended for a first recipient group;
allowing the user to identify a second portion of the message as intended for a second recipient group;
creating, based at least in part on the identified first portion of the message, a first electronic mail for delivery to the first recipient group;
creating, based at least in part on the identified second portion of the message, a second electronic mail for delivery to the second recipient group; and
sending the first and second electronic mails.

2. The method of claim 1, wherein at least one of the first recipient group and the second recipient group consists of a single recipient.

3. The method of claim 1, further comprising
allowing the user to identify additional portions of the message as intended for respective additional recipient groups;
creating, based on the identified additional portions of the message, respective additional electronic mails; and
sending the additional electronic mails.

4. The method of claim 1, comprising
allowing a generic portion of the message to be included in both the first and second electronic mails.

5. The method of claim 1, comprising
allowing the user to identify multiple parts of the message to be the first portion of the message, or allowing the user to identify multiple parts of the message to be the second portion of the message.

6. The method of claim 1, comprising
allowing the user to input the message;
allowing the user, subsequent to the user inputting the message, to identify the first portion of the message as intended for the first recipient group; and
allowing the user, subsequent to the user identifying the first portion of the message, to identify the second portion of the message as intended for the second recipient group.

7. The method of claim 6, wherein
allowing the user to identify the first portion of the message comprises allowing the user to click and drag a cursor icon over the first portion of the message.

8. The method of claim 1, wherein
creating the first electronic mail comprises including the first portion of the message in the first electronic mail but not including it in the second electronic mail, and
creating the second electronic mail comprises including the second portion of the message in the second electronic mail but not including it in the first electronic mail.

9. The method of claim 1, wherein allowing the user to identify the first portion of the message comprises:
allowing the user to select a first-recipient-group-mode, and
allowing the user to enter the first portion of the message after the user selects the first-recipient-group-mode; wherein
the identification of the entered first portion of the message as the first portion is based on the first-recipient-group-mode.

10. The method of claim 9, comprising
allowing the user to identify a location in the graphical window; and
allowing the user to enter the first portion of the message beginning at about the location.

11. The method of claim 9, wherein allowing the user to identify the second portion of the message comprises:
allowing the user to select a second-recipient-group-mode; and
allowing the user to enter the second portion of the message after the user selects the second-recipient-group-mode; wherein
the identification of the entered second portion of the message as the second portion is based on the second-recipient-group-mode.

12. The method of claim 11, comprising
allowing the user to toggle between selections of the first-recipient-group-mode and the second-recipient-group-mode, thereby allowing the user to modify the first and second portions of the message, wherein
the portion of the message being modified is based on a current recipient-group-mode selection.

13. The method of claim 12, wherein allowing the user to modify the first and second portions of the message comprises allowing the user to at least one of add to, delete from, and change the first portion and the second portion.

14. The method of claim 1, wherein sending the first and second electronic mails comprises sending text messages from a portable handheld wireless communication device.

15. The method of claim 1, wherein providing a graphical window for inputting a message comprises providing a graphical window on a screen of a portable handheld wireless communication device.

16. The method of claim 15, comprising
allowing the user to identify the first portion of the message by dragging at least one of a finger and a stylus over a portion of the screen, the portion of the screen being representative of the first portion of the message.

17. A system for allowing a user to send customized electronic mails to a plurality of recipients, comprising:
an electronic device for communicating with other electronic devices;
a display operably coupled to the electronic device for displaying a graphical window;
an interface for allowing the user to input a message to be displayed within the graphical window;
programmable memory for maintaining respective first and second membership lists of first and second recipient groups;
additional programmable memory for storing indicators identifying first and second portions of the message;
a parser for creating respective first and second electronic mails based on the first and second portions of the message and the first and second recipient groups; and
a transmitter for transmitting the electronic mails.

18. The system of claim 17,
wherein the electronic device comprises at least one of a personal digital assistant and a cellular telephone.

19. The system of claim 17, wherein the display is a touch-sensitive display for allowing the user to identify the first and second portions of the message by using a finger to select the first and second portions of the message.

20. A system for allowing a user to organize portions of an electronic mail message based on intended recipients of the portions of the electronic mail message, comprising:
an electronic device for communicating with other electronic devices;
an electronic touch-sensitive display operably coupled to the electronic device for displaying a graphical window;
an interface for allowing the user to input a message to be displayed within the graphical window;
programmable memory for maintaining respective membership lists for recipient groups;
programmable memory for storing respective indicators identifying portions of the message; and
programmable memory for storing indicators associating ones of the recipient groups with ones of the portions of the message.
